(19) United States
(12) Patent Application Publication
(10) Pub. No.: US 2009/0039060 A1
(43) Pub. Date: Feb. 12, 2009

(54) Lasercutting With Scanner

(76) Inventors: Niclas Palmquist, Torslanda (SE); Helena Larsson, Kungalv (SE)

Correspondence Address: FORD GLOBAL TECHNOLOGIES, LLC, FAIRLANE PLAZA SOUTH, SUITE 800, 330 TOWN CENTER DRIVE, DEARBORN, MI, 48126, US

(21) Appl. No.: 12/116,466

(22) Filed: May 7, 2008

(30) Foreign Application Priority Data
Aug. 8, 2007 (EP) 07107714.3

(51) Int. Cl. B23K 26/00

(52) U.S. Cl. 219/121.69

(57) ABSTRACT

The embodiments described relate to a laser cutting method suitable for cutting multilayered or painted materials such as for example car bodies. The method involves the step of scanning a low laser beam a plurality of turns along an intended cut edge. Utilizing the described cutting method, the paint located in the vicinity of the cut edge is only slightly affected by the heat generated by the laser beam.

### TECHNICAL FIELD

The present application relates to a method for cutting a painted or multilayer work piece wherein a laser beam having low average power and a high peak or pulse passes along a path to be cut.

### BACKGROUND

Laser cutting is a technology that uses a laser to cut materials and is usually used in industrial manufacturing.

Laser cutting works by directing a output high power laser at the material to be cut. The material then either melts, burns or vaporizes away leaving an edge with a high quality surface finish.

Advantages of laser cutting over mechanical cutting vary according to the situation, but important factors are: lack of physical contact (since there is no cutting edge which can become contaminated by the material or contaminate the material), flexibility of cutting shapes and to some extent precision (since there is no wear on the laser). There is also a reduced chance of warping the material that is being cut as laser systems have a small heat affected zone. Some materials are also very difficult or impossible to cut by more traditional means.

Traditionally, sheet-metal (e.g. in car bodies) is cut before it is painted. This is due to the fact that most techniques available for cutting generate heat which has a damaging effect on the paint next to the cut edge. It is not uncommon that the different paint layers can separate from each other due to the elevated temperature next to the cut giving rise to a growth point of long term corrosion. Punching is one of the methods which can be used to produce holes in the already painted sheet-metal. However, the punching technique is difficult to realize in visible areas as there is a big risk for deformations in the car body. Laser cutting in painted material (e.g. painted car bodies) have a number of advantages. Many times it is not until the car body has been painted that the final customer is known and the accessories and extra equipment are decided. Body in White variants can be reduced to a minimum by cutting of optional holes, chosen by the final customer, such as holes for GPS navigation antennas, spoilers, rails, various plastic moldings etc., at the very last moment before the car leaves the manufacturing line, which in turn results in minimized storage areas prior to final assembly. Assembly and guiding holes can be cut on the completed and painted car body, eliminating geometrical stack-ups and misalignments of holes, creating a better fit of parts whilst also reducing manpower for assembly and adjustment.

However, when traditional laser cutting processes are used on painted materials, a heat affected area next to the cut edge can sometimes be noticed.

An approach for preventing the formation of these growth points for corrosion is to use a laser having a low average power simultaneously with a high peak or pulse. The laser should also have a very high beam quality and scanning optics which will scan the laser beam along the intended cutting edge or seam. Multiple passes will create a cut while exerting a minimum amount of heat on the paint layers, thereby reducing the problem with long term corrosion.

### SUMMARY

One aspect of the invention provides a method for cutting a painted or multi-layered work piece by means of a scanned laser beam. The method comprises the steps of inputting into a computer or other like device a desired pattern obtained from a CAD-model or other suitable drawing program. The painted or multi-layered work piece material is then placed under a lens of an apparatus that produces a laser beam. The laser is started and the laser beam is directed towards the scanning mirrors. The scanning mirrors direct the path of the laser beam according to a preprogrammed pattern. The method further comprises the step of passing the laser beam repeatedly along the same preprogrammed path on the work piece until it has cut through the work piece material.

In one embodiment, the laser used is a Q-switched laser. In another embodiment, the laser used is a pulsed solid state laser.

In one embodiment, the laser beam moves in a superposed circular movement when a Q-switched laser is used.

In one embodiment, the wavelength of the laser beam is 1000-1100 nm, more preferably between 1010-1070 nm.

In yet another embodiment, the wavelength of the laser beam is 1030 nm for a Q switched laser.

In one embodiment, the wavelength of the laser beam is 1064 nm for a pulsed solid state laser.

In one embodiment, the pulse duration for the pulsed solid state laser is 0.08-1.0 ms, more preferably 0.1-0.3 ms and most preferably 0.15 ms.

In one embodiment, the pulse duration for the Q-switched laser is 0.02-1.0 ms, more preferably 0.03-0.1 ms and most preferably 0.05 ms.

In one embodiment, the pulse repetition rate for the pulsed solid state laser has a frequency of 0.1-1.5 kHz, more preferably between 0.1-0.5 kHz and most preferably a frequency of 250 Hz.

In one embodiment, the pulse repetition rate for the Q-switched laser has a frequency of 10-30 kHz, more preferably a frequency of 15-25 kHz and most preferably a frequency of 20 kHz.

In one embodiment, the average output energy is 65 W for the pulsed solid state laser.

In one embodiment, the average output energy is 60 W for the Q-switched laser.

### BRIEF DESCRIPTION OF THE DRAWING

FIG. 1 shows a laser beam cutting a work piece according to the method of the invention.

### DETAILED DESCRIPTION

In the following, embodiments will be described in more detail. However, the embodiments described below are only given as examples and should not be limiting to the present invention. Other solutions, uses, objectives, and functions within the scope of the invention as claimed below should be apparent for the person skilled in the art.

By using a laser having a low average power simultaneously with a high peak or pulse and with very high beam quality and scanning optics, a laser beam is scanned along an intended cutting edge or seam. The desired shape or pattern to be cut can be obtained from a CAD-model or other suitable drawing program and should be programmed into a microprocessor or other like device associated with an apparatus, such as a robot with an end effector, for moving the laser according to the predefined path. Alternatively, the part to be cut could be placed on a movable carriage or table that, in conjunction with a fixed laser beam, moves in according to the programmed patterned to achieve the desired cut. The switching on and off of the laser beam is programmed and the laser light is directed by an optical fiber or beam tubes to the scanner optics which comprises one or more movable mirrors 4, 5 which can move the beam in one plane. The computer program controls the scanner mirrors 4, 5 to direct the laser beam to follow the programmed pattern. The mirrors 4, 5 are made from quartz glass which has been coated by a substance giving a surface which reflects the wavelength of the laser beam. The movable or oscillating mirror or mirrors are controlled by piezoelectric motors. If two mirrors are used, the laser beam is directed in the x direction by one of the mirrors and in the y direction by the second mirror. By combining the movements of the two mirrors, the beam can move around in a plane and for example make a circular or a square hole. The laser beam can also be directed by one single mirror.

Due to the high pulse energy, a thin layer of material, initially coats of paint and later metal, is removed by laser ablation during each passing of the laser beam. Multiple passes will eventually create a cut while exerting a minimum heat on the paint layers. The depth over which the laser energy is absorbed, and thus the amount of material removed by a single laser pulse, depends on the material's optical properties and the wavelength of the laser. Laser pulses can vary over a very wide range of duration (milliseconds to femtoseconds), and can be precisely controlled. Ablation depth is determined by the absorption depth of the material and the heat of vaporization of the work material. The depth is also a function of beam energy density, the laser pulse duration, and the laser wavelength. Suitable lasers can be pulsed lasers, usually used for laser marking or remote welding which have a relatively low duty cycle, or a continuous laser which is shuttered. However, in order to exert a minimal heat effect, the pulsed laser is preferable. Suitable lasers can be a pulsed solid state laser such as HL101P or a Q-switched laser.

There are several parameters to consider for laser ablation. The first is selection of a wavelength with a minimum absorption depth. This will help ensure a high energy deposition in a small volume for rapid and complete ablation. Wavelengths used in the present invention are in the range of 1000-1100 nm, and more preferably between 1010-1070 nm. When a Q-switched laser is used the most preferred wavelength is 1030 nm and for a pulsed solid state laser the most preferred wavelength is 1064 nm.

Another parameter is the pulse duration, which has to be very short in order to maximize the peak power while the thermal conduction to the surrounding work material is kept at a minimum. This is analogous to a vibrating system where the mass is large and the forcing function is of high frequency. This combination will reduce the amplitude of the response. As soon as the laser beam hits the surface of the material, the material vaporizes immediately, which prevents heat transport to the surrounding material. For the pulsed solid state laser, short pulses in the range of 0.08-1.0 ms are used, more preferably pulses in the range of 0.1-0.3 ms and most preferably a pulse of 0.15 ms is used. For a Q-switched laser the pulse duration was shorter, 0.02-1.0 ms, more preferably 0.03-0.1 ms and most preferably a pulse of 0.05 ms was used.

A third parameter is the pulse repetition rate. If the rate is too low, all of the energy which was not used for ablation will leave the ablation zone allowing cooling. If the residual heat can be retained, thus limiting the time for conduction, by a rapid pulse repetition rate, the ablation will be more efficient. More of the incident energy will go toward ablation and less will be lost to the surrounding work material and the environment. For the pulsed solid state laser the optimal pulse frequency is between 0.1-1.5 kHz, more preferably between 0.1-0.5 kHz and most preferably a frequency of 250 Hz is used. For the Q-switched laser a frequency of between 10-30 kHz is suitable, more preferably a frequency of 15-25 kHz and most suitable is a frequency of 20 kHz.

Another parameter is the beam quality expressed as the Beam Parameter Product (BBP). Beam quality is measured by the brightness (energy), the focusability, and the homogeneity. In one embodiment, the BPP will be 1-15 mm×mrad for both types of lasers. The beam energy is of no use if it cannot be properly and efficiently delivered to the ablation region. Further, if the beam is not of a controlled size, the ablation region may be larger than desired with excessive slope in the sidewalls. The maximum pulse energy used in the present invention is 4 kW for the pulsed solid state laser, having an average pulse energy of 65 W. For the Q-switched laser a maximum pulse energy of 3 kW and average of 60 W was used. During the cutting procedure it can sometimes be noticed that the laser beam has difficulties cutting through the work piece. After a certain cutting depth is reached the walls of the cut cave in and the laser beam is not able to cut any deeper. In order to solve this problem, when using a Q-switched laser, the laser beam advantageously moves with a superposed circular movement a long the cutting line on the work piece. This creates a smooth cutting edge slightly slanted towards the cut.

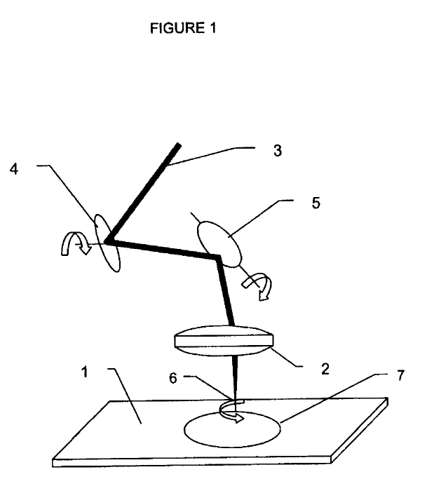

A method for cutting a painted or multi-layered work piece by means of a scanned laser beam is described with reference to FIG. 1. The method comprises the steps of programming a microprocessor or a computer or other like device with the desired pattern obtained from a CAD-model or other suitable drawing program. Next, the painted work piece material or car body (1) is placed in a working area under the lens (2) of the laser. The laser is started whereby the laser beam (3) is directed towards the scanning mirrors (4, and 5). The scanning mirror (4) or mirrors (4 and 5) direct the path for the laser beam (3) by means of a robot or indexing unit (not shown) according to the preprogrammed pattern. The laser beam (3) passes repeatedly along the same preprogrammed path (7) on the work piece or car body (1) until it has cut through material. Optionally, the laser beam moves with a superposed circular movement (6) a long the cutting line on the work piece. In another embodiment, the laser beam is stationary and the carriage or work table holding the workpiece moves according to the pre-programmed path.

### EXAMPLE 1

A Q-switched laser was used for cutting a square hole 19×19 mm in a 0.8 mm thick zinc coated sheet-metal covered with a 100 μm paint layer using the above described method. The wavelength was set at 1030 nm, with a pulse frequency of 20 kHz, a pulse duration of 0.05 ms and the laser beam had an average effect of 60 W. The laser beam required 72 revolutions which took 32 seconds before the beam cut through the work material. The cut edge was smooth and had no visible signs of deformations or heat affected areas in the paint when the edge was examined under a microscope at ×25 enlargement.

### EXAMPLE 2

The same Q-switched laser, having the same parameters as in Example 2 were used to cut a square hole 19×19 mm in a 0.8 mm thick zinc coated sheet metal covered with a 400 μm thick paint layer. Also in this example the laser beam required 72 revolutions or 32 seconds to cut through the work material.

1. A method for cutting a workpiece with a laser having an articulating mirror and a lens and being operative to generate a laser beam, comprising the steps of:
focusing the laser beam towards the mirror and moving the mirror to direct the laser beam according to a preprogrammed travel path; and
repeatedly passing the laser beam along the preprogrammed travel path on the workpiece to cut the workpiece.
programming a desired travel path into a microprocessor associated with said laser;
placing the work piece under the lens;
directing the laser beam towards the mirror;
moving the mirror according to a preprogrammed path; and
passing the laser beam repeatedly along the same preprogrammed path on the work piece until the laser beam has cut through the work piece.
a) Loading a computer with the desired pattern obtained from a CAD-model or other suitable drawing program.
b) Placing the painted or multi-layered work piece material 1 under the lens 2.
c) Starting the laser whereby the laser beam 3 is directed towards the scanning mirrors 4, and 5.
d) Directing the path for the laser beam 3 by the scanner mirror 4 or mirrors 4, and 5 according to a preprogrammed pattern.
e) Passing the laser beam 3 repeatedly along the same preprogrammed path 7 on the work piece 1 until it has cut through the work piece material.

2. A method according to claim 1, wherein the laser used is a Q-switched laser.

3. A method according to claim 1, wherein the laser used is a pulsed solid state laser.

4. A method according to claim 2, wherein the laser beam moves in a superposed circular movement.

5. A method according to claim 1, wherein the wavelength of the laser beam is between 1010-1070 nm.

6. A method according to claim 1, wherein the wavelength of the laser beam is 1030 nm for a Q switched laser.

7. A method according to claim 1, wherein the wavelength of the laser beam is 1064 nm for a pulsed solid state laser.

8. A method according to claim 1, wherein the pulse duration for the pulsed solid state laser is 0.08-1.0 ms.

9. A method according to claim 1, wherein the pulse duration for the Q-switched laser is 0.02-1.0 ms.

10. A method according to claim 1, wherein the pulse repetition rate for the pulsed solid state laser has a frequency of 0.1-1.5 kHz.

11. A method according to claim 1, wherein the pulse repetition rate for the Q-switched laser has a frequency of 10-30 kHz.

12. A method according to claim 1, wherein the average output energy is 65 W for the pulsed solid state laser.

13. A method according to claim 1, wherein the average output energy is 60 W for the Q-switched laser.

14. A method for cutting a workpiece with a laser having a pair of articulating mirrors and a lens and being operative to generate a laser beam, comprising the steps of:
programming a desired travel path into a microprocessor associated with the laser;
placing the work piece under the lens;
focusing the laser beam towards the pair of mirrors;
moving the pair of mirrors so as to direct the laser beam according to a preprogrammed travel path; and
passing the laser beam repeatedly along the same preprogrammed path on the work piece until the laser beam has cut through the work piece.
